(19) United States
(12) Patent Application Publication
(10) Pub. No.: US 2015/0278462 A1
(43) Pub. Date: Oct. 1, 2015

(54) HIPAA COMPLIANT DATA COLLECTION AND FRAUD PREDICTION SYSTEM AND METHOD

(71) Applicant: Medicfp LLC, Hollywood, FL (US)

(72) Inventors: ROBERT SMOLEY, AVENTURA, FL (US); ALLAN VOSS, BONITA SPRINGS, FL (US); VICTOR COOK, HOLLYWOOD, FL (US); ADAM MIZRAHI, MIAMI, FL (US); SEYWARD FRAIHA, PLANTATION, FL (US); WILLIAM GUNTHER, LAKE WORTH, FL (US); ROMAN JURKOV, DELRAY BEACH, FL (US); DOUGLAS WITHERSPOON, HOLLYWOOD, FL (US); GAGAN BAHETY, DELRAY BEACH, FL (US); NEVILLE PITTERS, PEMBROKE PINES, FL (US)

(21) Appl. No.: 14/668,307

(22) Filed: Mar. 25, 2015

Related U.S. Application Data
(60) Provisional application No. 61/970,041, filed on Mar. 25, 2014.

(51) Int. Cl. G06F 19/00

(52) U.S. Cl. CPC G06F 19/328

(57) ABSTRACT

A system and method are provided for determining a probability of healthcare fraud and for providing a report identifying the determined probability to a Healthcare Provider or Payer. For example, the system verifies insurance eligibility using a presenting individual's insurance card and an officially issued government ID card (i.e., one for which the issuing Agency maintains an electronic photograph on file of the individual to whom the ID card was issued) and/or a biometric of the presenting individual. Additionally, data is collected from Electronic Medical Records, analyzed and packaged to identify possible fraud.

### CROSS-REFERENCE TO RELATED APPLICATIONS

The present application claims priority from co-pending Provisional Patent Application No. 61/970,041, filed on Mar. 25, 2014; that application being incorporated herein, by reference, in its entirety.

### BACKGROUND OF THE INVENTION

1. Field of the Invention

The invention relates to a HIPAA compliant data collection system and method and, more particularly, to a HIPAA compliant data collection system and method utilizing a rules engine to learn patterns of fraud and predict occurrences of probable fraud.

2. Description of the Related Art

Healthcare fraud costs the system billions of dollars every year. Healthcare fraud can occur as the result of, on the Provider side, phantom billing, padded billing, double billing, upcoding, unbundling, and outright theft of Provider identities, among others. On the Patient side, healthcare fraud can take the form of prescription fraud, identity theft, forum shopping (Provider and pharmacy), and substance abuse/dealing. Such fraud can be hard to identify prior to the payout of a claim by the health insurance/Medicare/Medicaid industry.

What is needed is a system and method that collects data and, from this data, lets the system flag various forms of fraud.

### BRIEF SUMMARY OF THE INVENTION

It is accordingly an object of the invention to provide a HIPAA compliant data collection system that uses statistical patterns in order to flag various forms of fraud. In one particular embodiment of the invention, the system analyzes both real-time and historical data to learn statistical patterns.

In one particular embodiment of the invention, the system operates to identify a Patient and confirm the Patient's identity at check-in; validate that the Patient to be treated is covered by insurance and/or Medicaid; and ensure the Patient is present at the visit.

Although the invention is illustrated and described herein as embodied in a HIPAA Compliant Data Collection and Fraud Prediction System and Method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a block diagram of an adaptive fraud prediction system in accordance with one particular embodiment of the invention;

FIG. 2 is a block diagram of an adaptive fraud prediction system in accordance with one particular embodiment of the invention;

FIGS. 3-4 are flow charts showing a method of generating a Fraud ProbabilityReport in accordance with one particular embodiment of the present invention;

FIG. 5 is a Fraud ProbabilityReport in accordance with one particular embodiment of the present invention;

FIG. 6 is an interaction diagram for a system in accordance with one particular embodiment of the present invention;

FIG. 7 is a block diagram of an adaptive fraud predication system in accordance with one particular embodiment of the invention; and

FIG. 8 is a representative block diagram of a system for providing information of a Delivered Medical Equipment or Home Healthcare visit to a Health Information Exchange in accordance with one particular embodiment of the invention.

### DETAILED DESCRIPTION OF THE INVENTION

The data collection system of the present invention flags various forms of fraud by analyzing both real-time and historical data. In one particular embodiment, the invention utilizes an adaptive algorithm that learns from statistical patterns to identify fraud. The invention can, thus, identify fraud and provide that information to insurance companies and/or government in real-time. In one particular embodiment of the invention, an analytics indicator is provided so that government/insurance can address the fraud before any disbursements are made.

Once a prediction of likelihood of fraud has been made by the system, the government/insurer is free to determine how they want to use the information when authorizing and/or paying for services. In particular, an insurer/government provider can review minute by minute information, and/or can receive information summaries monthly, quarterly, etc. Reports can be generated that identify significant statistical outliers. This can be used to point out fraudulent activities and to stay ahead of ever changing fraudulent schemes. Additionally, particular provider billings can be sampled against all of the data captured by the system (including every Provider and/or beneficiary in the system) to learn and identify patterns of fraud in order to alert the government and/or an insurance provider.

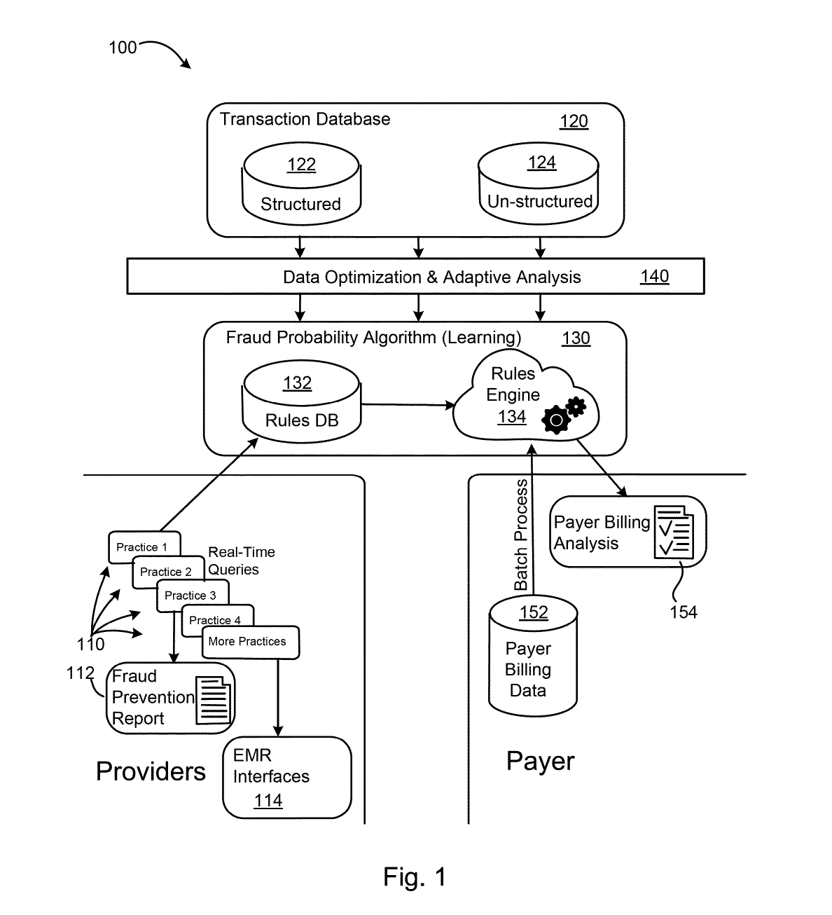

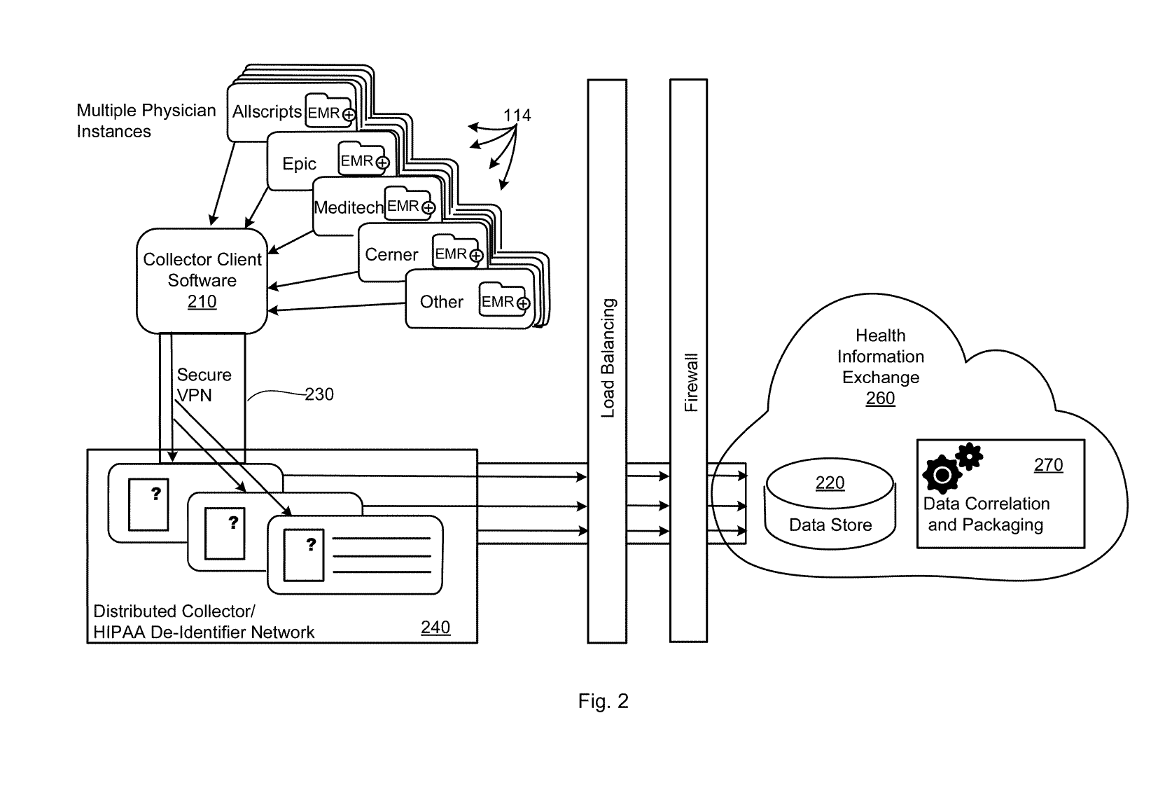

Referring now to FIGS. 1 and 2, an adaptive fraud prediction system 100 in accordance with one particular embodiment of the invention is provided. More particularly, data is collected in the system from electronic medical records to learn patterns of fraud. More particularly, the adaptive fraud prediction system 100 is disposed separately from individual medical facilities and healthcare practices 110 and provides a Health Information Exchange (HIE) 260 wherein data, including de-identified data, is stored and where data correlation and packaging can occur.

A number of different types of electronic medical record (EMR) systems can be supported by the present invention. Any number of physician practices 110 may be using each of the different types of electronic medical records (EMRs), via different EMR system interfaces 114. Each one of these EMR systems becomes a source of data stored in a transaction database 120.

Collector client software 210, is installed in the EMR system of each of the physician practices 110, or in a data center serving these practices 110. The collector client software 210 obtains the data from each Patient record stored in a physician's EMR system. For example, in one particular embodiment of the invention, the collector client software 210 can operate as an intelligent software agent residing the physician's system, which mines data from EMRs upon entry. As such, in this embodiment, data can be made use of in real-time. The collector client software 210 can send data to the distributed collection network 240 (i.e., the transaction database 120; Data store 220) via a secure network connection 230, such as a virtual private network (VPN) connection. By transferring the data over a secure channel, the present system protects patient privacy. The distributed collection network servers (represented by the Distributed collector/HIPAA De-identifier Network 240) take the Patient data and de-identifies and transforms the data to be stored and used in an adaptive fraud detection system 100 in accordance with one particular embodiment of the present invention. Incoming and de-identified data are stored in the structured data store 122 and unstructured data store 124, as appropriate. The transformation and de-identification of the data preserves the privacy of individuals not involved in fraud. The data collected is then provided to a data store 220 of an HIE 260 for data correlation and packaging by the analysis software 270. More particularly, the HIE 260 is a data-gathering tool that ingests data from practice management software and electronic health record systems 114, and other software. This data is then served up to a fraud prevention rules system 130 for use in notifying interested parties of a prediction of fraud and for producing reports 112.

The adaptive fraud prevention system 100 of the present embodiment takes the data collected by the collector client software 210 and de-identified/transformed by the data collection system 240 and uses it to learn patterns of fraud. Additionally, if desired, the adaptive fraud prevention system 100 can be connected, in real-time, to existing healthcare and government databases containing data that can be analyzed and used by the system 100. The system 100 is provided with a fraud probability algorithm 130, stored in a memory device of a computer and executable by a processor of a computer associated with the memory device, that analyzes the data to find patterns that are defined in a rules database 132. A rules engine 134 uses the rules existing in the rules database 132 to process requests for a “Fraud Probability Report” or “Integrity Report” from physician practices 110. In one particular embodiment of the engine 134, the rules engine 134 is a software module stored in a non-transitory memory of a computer server and executed by a computer processing device. In making the requests, client software provides a secure connection from the physician practices 110 to the adaptive fraud prevention system 100 of the present invention.

Additionally, the rules engine 134 of the present embodiment improves the rules stored in the Rules DB 132 by analyzing new data from the EMRs (i.e., using data optimization and adaptive analysis at 140). Systems of this kind are often known as “Learning Classifier Systems” or “Genetic Algorithms” (See, for example, U.S. Pat. No. 8,321,341 to Nandy, entitled “Online fraud prevention using genetic algorithm solution”, incorporated herein by reference). Note that this is not meant to be limiting, as other types of algorithms may be used without departing from the scope and spirit of the present invention.

In one particular embodiment of the invention, some or all of the bills (i.e., billing data 152) coming in to a Payer (which, in one particular embodiment is an insurance payer) are sent to the adaptive fraud prevention system 100 of the present invention to be analyzed for fraud probability. A report 154 on the probability of fraud is returned to the Payer before payment is made. This prevents payment from being made on fraudulent bills. Additionally, to improve bill verification, the system 100 can scrub or mine data from Provider submitted bills 152 and compare the data to the data (122) stored during the visit (via data correlation 270) to ensure a match or to detect inaccuracies.

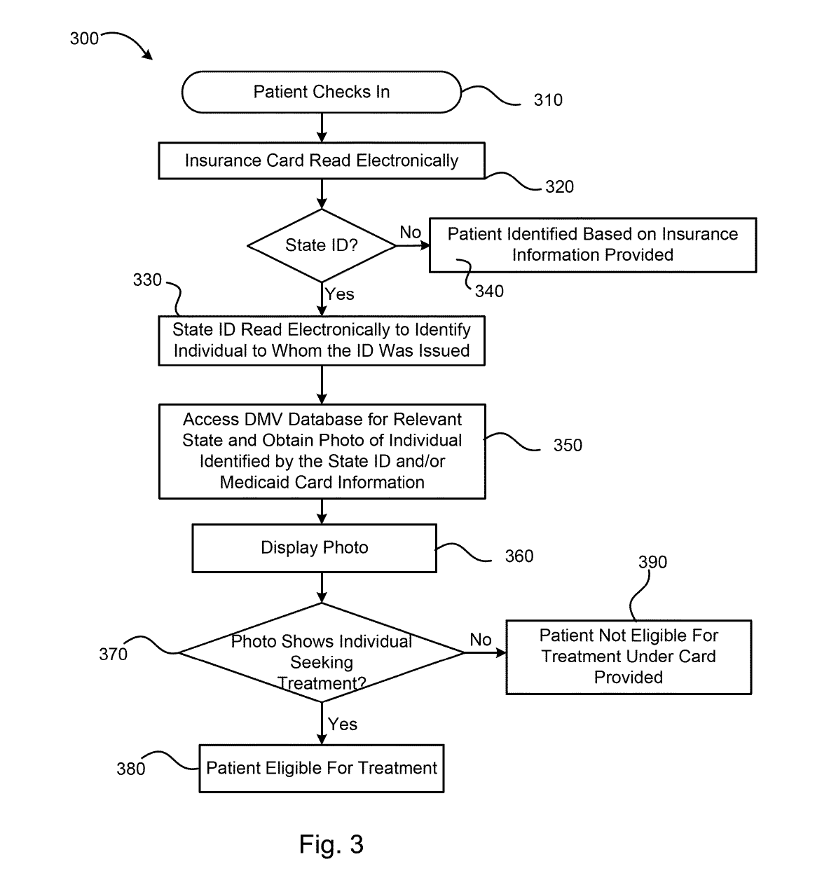

Referring now to FIGS. 1-4, one particular embodiment of a method 300 of using an adaptive fraud prevention system 100 will be described in connection with a Medicaid Patient. Note that the present invention is not limited only to Medicaid Patients, but can be modified to have other Insurer or payer systems without departing from the scope of the present invention. Additionally, It should be understood that the system of the present invention is executed using a computer system configured by software to implement particular embodiments of the present invention.

In the present particular embodiment of the invention, each practice 110 includes a computerized electronic medical records system that can interface with the fraud prevention system 100. In one particular embodiment, the staff member or Provider accesses the fraud prevention system 100 of the present invention via a computer having an input device (such as a keyboard and/or mouse) and a display device. A Provider login screen viewed at a computer of the particular practice 110 can assist with the check-in process. In one embodiment, the software of the present embodiment is configured to provide an application “dashboard”, a type of visual/graphical, software-based control panel, accessible to the staff member or Provider after logging-in to the fraud prevention system 100. From the dashboard, the Provider may, among other things, view Patient records, create new Patient records (i.e., enter new Patients into the system) and receive and/or send alerts.

Additionally, if a Patient has presented for treatment at a practice 110 the Patient can be checked-in by a staff member or Provider by selecting an option from the dashboard that initiates a check-in procedure for the Patient. As discussed above, in one particular embodiment of the invention, the Provider requests an insurance card from the Patient as part of the check-in process. Step 310. In the present, non-limiting example, the insurance card provided by the Patient is a Medicaid card. In this example, the Provider electronically reads information stored on the Patient's Medicaid card. For example, the Patient information can be stored electronically on a magnetic stripe on the Medicaid card and the Provider electronically reads this information by swiping the magnetic stripe in a magnetic card reader to electronically obtain the Patient information. As discussed herein, the information can be stored on the card using other types of electronic systems, including, but not limited to, smartcard reader, passive near-field electronic ID reader, OCR or another type of electronic reader.

The Insurance card is read electronically (i.e., via a magnetic strip reader, smartcard reader, passive near-field electronic ID reader or another type of electronic reader). Step 320. Additionally, in the present particular embodiment, the Patient is also asked to produce a recognized officially issued state or federal identification card or other officially issued ID card, such as a driver's license, state ID or federal government ID. In the most preferred embodiment, the provided officially issued ID card can be read electronically, since the electronic reading of the ID card provides conclusive proof that the Official ID was present at the visit. Thus, if the Patient has such an ID, it is read electronically to provide additional identity data. Step 330. If no such State ID is provided, the system will attempt to identify the Patient based on the Insurance information provided. Step 340.

Using the information from the Medicaid card and/or the State ID, the system accesses the Department of Motor Vehicles (DMV) database for the relevant state and obtains a driver's license photo or state ID photo associated with the individual identified by the State ID or the Medicaid card information. Step 350. The photo is displayed on a display device in the physician's practice (Step 360) and an employee of the practice is asked to confirm that the Patient requesting treatment is indeed the person shown in the DMV database photo (Step 370). This permits a physician/Provider to properly identify the beneficiary, the proper insurance/Medicaid/Medicare eligibility, and relevant recent Patient history. With this information, Providers can ensure that they are treating the right person and that the person is eligible for benefits. Steps 380, 390. Thus, validation of the beneficiary's identity takes place at the point-of-service (i.e., the facility check-in) and at every Provider location in the health care system (i.e., hospitals, doctors' offices, pharmacies, laboratories, diagnosticians, etc.). Additionally, in one particular embodiment of the invention, electronically reading the information stored on the state ID provides a further indication that the Patient is present (which is necessary in order to produce a card that can be read electronically) and this information can be stored to prove the presence of the Patient at a particular location at a particular day and time, in order to reduce the occurrence of phantom billing practices. For example, by collecting basic information about the check-in process (e.g., state IDs typically not read for Patients of a particular physician; biometric verification is not used), the system can verify whether or not a Patient was present for a visit. By collecting details relating to Patient presence verifications (i.e., for a particular Provider or practice), Payers can easily highlight potential phantom billers.

After a Patient is verified in Step 380, in one particular embodiment of the invention, the Patient is asked to complete a basic medical questionnaire. Step 410. The questionnaire can ask questions such as, for example, the relationship of the Patient to the beneficiary; the reasons for which the Patient is requesting care; whether or not the Patient has seen another Provider for this or a similar condition/complaint; etc. The information is provided to the adaptive fraud detection system for processing and for Patient identification. Steps 420, 430. A Fraud Probability Report 112 can be generated by the rules engine 134 based on the rules defined in the rules database 132. Step 440. The Fraud Probability Report 112 can be used to verify, among other things: the identity of the Patient; the Patient's eligibility for insurance coverage and/or Medicaid coverage; and the Patient's recent medical activity. In one particular embodiment, a Fraud Probability Report 112 is printed for use by the physician/Provider while seeing the Patient and/or stored in an EMR associated with the Patient. Thus, once the check-in process has been completed, and before the Patient is treated, the system of the present embodiment automatically generates a color-coded, highly-graphical, and easy to understand report of fraud probability. After seeing the Patient, the staff or Provider can use the dashboard to close out the Patient from active/open lists and to input relevant information to the system and the EMR.

As will be discussed below, the Fraud Probability Report 112 also includes information indicating a level of probability of fraud being committed by the presenting Patient. The physician can review the Fraud Probability Report 112 and its fraud probability level indicators in order to decide how to treat the Patient. Note that the system of the present invention offers the physicians/Providers with a report outlining the probability of fraud, such as identity fraud, ineligible benefits, doctor shopping or potential substance abuse. The final decision on Patient care is left to the physician/Provider. The system of the present invention does not, itself, prevent or deny medical services to Patients.

Additionally, the Fraud Probability Report 112 offers the Provider an easy to use report outlining the probability of fraud, in real-time, at the time the Patient checks in. The Fraud Probability Report 112 provides an analysis of recent Patient medical history, identification and insurance/Medicaid/Medicare eligibility. In accordance with HIPAA regulations, the system of the invention only collects and retains the pertinent information needed to achieve its mission. Personal Patient data is not released to any outside party.

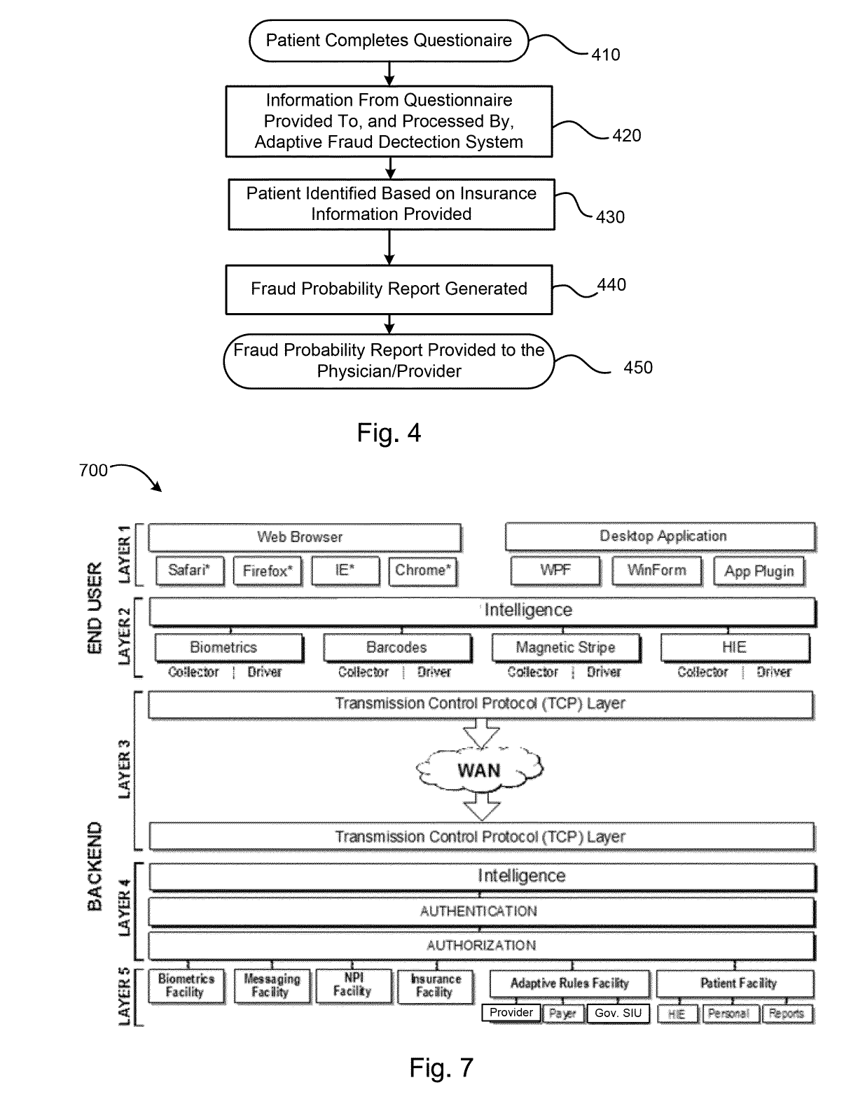

One particular illustrative example of a Fraud Probability Report 112 that can be generated from the present invention is shown in FIG. 5, wherein reference number 510 identifies a fraud probability level indicator generated using the rules stored in the rules database. Note that this is not meant to be limiting, as other formats and information can be used without departing from the spirit of the present invention. Additionally, verification details 520, used to generate the fraud probability report, can also be printed as part of the report 112.

Additionally, if desired, more than one fraud probability level indicator 510 can be provided for different aspects of the Patient visit. Additionally, the Fraud Probability Report 112 can be used by the Payer to determine the probability of fraud before payment is made. In the presently described embodiment, the fraud probability level indicator is illustrated as a slider 510 showing a point along a scale indicating the determined level of probability that the Patient transaction may be fraudulent. As seen, the point, determined using the rules engine based on the stored rules, can indicate to the Provider/Physician that the likelihood that the transaction is fraudulent is one of High, Medium, Fair or Low. This is meant for exemplary purposes only, as other gradations may be provided. Additional to, or instead of the level indicator, the Fraud Probability Report 112 can represent the determined probability level as a numerical percentage of the likelihood of fraud (i.e., a percentage determined based on the rules, for example, 73% instead of merely placing a point relative to the scale in FIG. 5). Additionally, in one particular embodiment of the invention, the risk probability scale is color-coded for easy reading (i.e., a color can be associated with level of risk, such as, red for high—green for low, etc.).

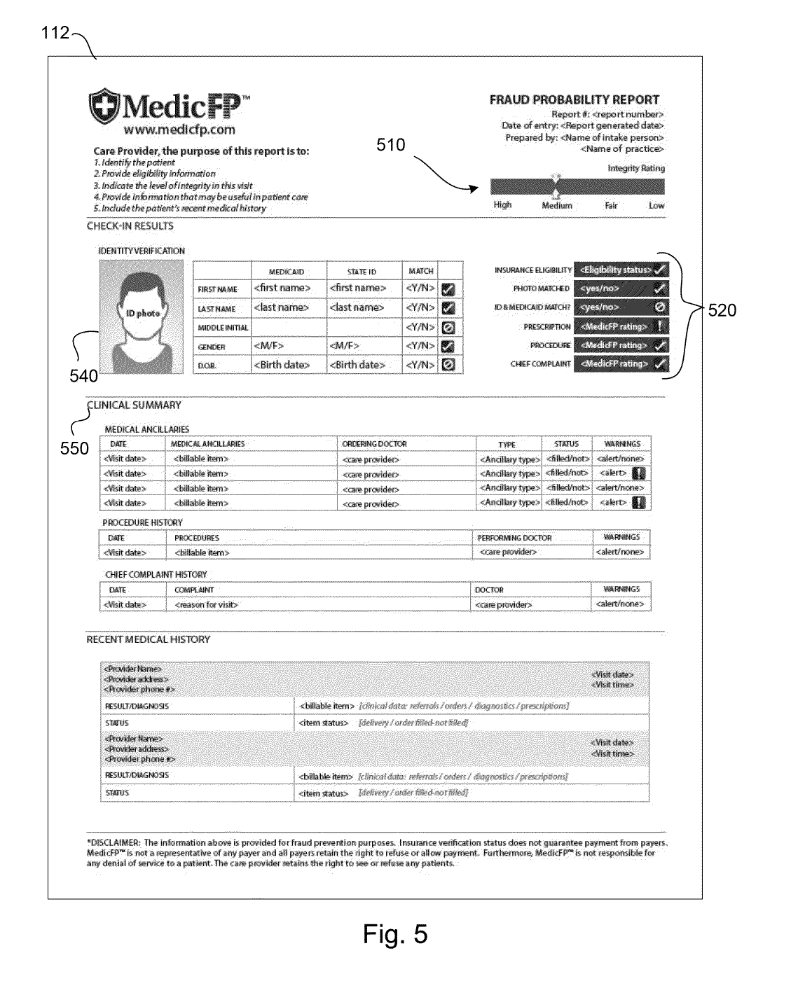

The Fraud Prediction Report 112 offers healthcare Providers an easy to use report outlining the probability of fraud at check-in. The Report 112 is generated automatically with the installed client software (i.e., the Verification Services System of FIG. 6) during each Patient verification and before the beneficiary receives treatment. The system analyzes recent Patient medical history using data provided from the HIE, including previous visits, recent prescriptions, identification verification, Insurance and/or Medicaid eligibility, and other factors to determine the probability of fraud. The Fraud Prediction Report 112 provides doctors and other Providers with an easy to understand rating system that identifies potential fraud or abuse. Consequently, in contrast to other EMR systems, the present invention provides doctors transparency and the tools needed to identify fraud, improve Patient care, and make medical decisions with a more complete overview of recent Patient history.

The fraud prediction rating 510 is accumulated via careful consideration of a variety of factors that impact the visit. Factors considered include, but are not limited to:

Drug seeking behavior;

Biometric Information;

Identity verification;

Cross validation success or failure;

Presence verification (e.g., biometric; state ID swipe);

Beneficiary Identification details to State Identification details cross validation;

Clinical Inconsistencies;

Complaint History;

Duplicate services; and

Other rules as are determined by the learning classified system predictive algorithms.

New rules may be added, as the rating system is scalable. By implementing a scalable fraud rating system the Fraud Prediction Report 112 can grow and evolve as fraud grows and evolves. By scoring and weighing each of the factors affecting the Patient check-in, a final score is generated and provided which indicates a prediction of a level of fraud probability associated with a visit, even before treatment has been provided.

Additionally, by including the Patient's DMV photo 540 as part of the Report 112, all Providers interacting with that Patient during that visit will be able to easily determine if the Patient appearing in front of them is the intended beneficiary. By performing back-end, validation cross checks against the beneficiary ID and the identification details provided by the Patient at check-in, the Report 112 is able to graphically display any identification concerns or inconsistencies that might effect the fraud probability rating of the visit. Additionally, identification details are acquired via a variety of methods, which may be expanded thanks to the scalable system design. Possible sources for providing identification include state IDs, Electronic Health Record integration, and electronic beneficiary look-up, including DMV and Eligibility look-ups.

Also, the Report 112 includes a clinical summary of the Patient's medical history. By providing a clinical summary, the Provider is better able to quickly understand many of the circumstances that are crucial to a Patient history and fraud probability. Through integration with the HIE, a detailed summary of services that the Patient has received, or is awaiting receipt of, is made available categorically. Within the clinical summary, any items flagged as being suspicious are highlighted for the Provider's consideration. Consequently, using the HIE, a recent Medical History for the Patient is populated, and analyzed in the report for factors that may affect the prediction of fraud. Clinical factors analyzed could include, but are not limited to: Prescription History; Clinical History; Frequency of Visits; and Chief Complaints.

By using a combination of visual aides the Report 112 is easy to use and understand. Visual aides that can be used include, but are not limited to:
Icons to indicate if the Beneficiary Identification details to State Identification details cross validation was successful or unsuccessful;
A photo of the actual beneficiary allows the Doctor to determine if the Patient present is the same as the insured beneficiary;
A color coding system to inform the reader of risk factors;
Actionable Alert Icons within the Check-in results detailing the results of the Integrity Check;
Icons raised next to flags dependent upon the severity of the Risk;
Icons raised in the Clinical Summary 550 next to items that have risk associated with them;
Highlighting risk items within the Clinical Summary 550; and/or
Visually representing the level of integrity associated with the visit (in this example, High, Medium, Fair, Low).

Referring now to FIGS. 1, 2 and 6, an interaction diagram 600 for a fraud prevention system 100 in accordance with a further particular embodiment of the invention will now be described. The interaction diagram 600 details the interactions between an End User (e.g., a practice 110), an Electronic Health Record System (EHRS), an identity verification system or Verification Services system (VSS) provided by the instant invention, and a Health Information Exchange (HIE). The HIE of the present invention extends traditional health exchanges by collecting Patient identity validation data, presence confirmation data and biometric verification. This additional information adds a higher level of accuracy to the data accumulated in the HIE. In addition to clinical data, the HIE of the present embodiment also collects unique visit data, such as, but not limited to: if the Patient receiving care had a state ID at check-in; if the state ID information matched the information provided by the insurer; if the Patient checked-in using successful or unsuccessful biometric verification; a time and date of the interaction; an identity of the person checking in the Patient; and an integrity level assigned to the encounter.

Once a Patient has presented for treatment, the End User initiates a Patient check-in procedure. An Electronic Health Record (EHR) or Electronic Medical Record (EMR) (the two terms being used interchangeably herein), or another type of electronic record is created or updated in a patient administration system (PAS) located at the health care provider. In the present embodiment of the invention, an Electronic Health Record System (EHRS) is provided that integrates with a PAS system. An EHRS resides at each practice 110 (i.e., the electrical medical record interfaces 114 of FIG. 2) and is used to input and store EHR data in a transaction database 122. Such data can include, but is not limited to, name, date of birth, gender, insurance type(s), if the payment is in cash, information regarding a Patient's insurance ID(s), a Patient's EHR/EMR unique identifier (UID), an EHR/EMR visit unique identifier (visit UID), the Provider type, name of the current system user, hospital type, etc. Note that this is not meant to be limiting, as more or less information can be provided to and from the EHRS without deviating from the scope and spirit of the present invention. The information entered into the EHRS local to each practice 110 is then provided to the VSS, in accordance with the present invention.

In one particular embodiment of the present invention, the VSS is enacted by software residing on a computer local to, and/or accessible by, each practice 110. In a most preferred embodiment, the VSS software resides in every Provider's practice office and is employed during the Patient check-in process to ensure Patient eligibility and confirm presence of the eligible beneficiary. The VSS collects, in real-time, information regarding a Patient's insurance eligibility and presence. In particular, among other information collected, the VSS collects information about a state ID presented by the Patient, biometric evidence and photographic evidence. Other details of a visit collected by the VSS can include, but are not limited to, type of physician, physician address, intake clerk identity, attending physician name, visit time, visit location and/or geographic location.

The VSS can be implemented in software, such as, by an installable computer application program, or can be configured as a web-based browser plug-in, as desired. If desired, the VSS can be used as a stand-alone application program or it can be interfaced directly to the Provider's Electronic Health/Medical Record System (EHRS) or Practice Management system (PMS). The VSS provides the practice 110 with an interface that directly connects to the EHRS to extract information (automatically and invisibly) without impacting existing office workflow. In the present preferred embodiment, the VSS operates in the background, behaving as a “listener” that collects and analyzes check-in and check-out data from each Patient visit. Additionally, the VSS software is communicatively connected to the HIE 260. As such, processing Patients with the VSS provides Patient visit data to the HIE.

In the present particular embodiment illustrated in FIG. 6, to confirm eligibility both of a primary identity verification and a secondary identity verification are performed.

Primary Identity Verification:

In accordance with the present embodiment, primary verification is performed by comparing and validating at least two forms of personal identification. In the present preferred embodiment, the VSS uses the individual's insurance and/or Medicaid card. Typically, this is validated by the Provider's EMRS. Additionally, the VSS of the present embodiment intervenes in the check-in process and directs the check-in clerk or staff member to enter information from the Patient's officially issued state or federal identification card (typically a driver's license), if available. This is done, as explained above, most preferably by electronically reading a data store of the officially issued state or federal identification card (hereafter referred to as the “Official ID”) with an electronic reader associated with the VSS. Less preferably, information from the officially issued state or federal ID can be manually entered into the VSS. In one particular embodiment, a magnetic stripe on the back of the Official ID is read by swiping the Official ID magnetic stripe through a magnetic stripe scanner/reader to automatically read the electronically encoded information on the license and input the Patient's name and license number into the system, which then uses these data to access a database of the appropriate state's Department of Motor Vehicles (DMV) or other Official ID issuing authority, to retrieve the Patient's information and picture. If desired, the VSS can match the Patient's insurance information to the DMV information in the event that the Patient does not have a drivers license or state-issued ID. In such a case, the insurance information is used to query the state or federal database to produce a photo of the beneficiary or to confirm that no Official ID exists for the beneficiary.

The retrieved picture is displayed locally to the check-in clerk by the VSS with a query regarding whether or not the picture matches the Patient presenting to the clerk. By confirming whether a DMV photo provided by the VSS matches the Patient present, the adaptive fraud prediction system of the present invention can identify fraud such as identity theft or “borrowed” IDs.

Secondary Identity Verification:

In addition to validating the Patient's identity through DMV or other state agency information, the VSS can, in the present embodiment, employ a biometric device to perform a secondary identity verification, if desired. Such a biometric device can include, but not be limited to one or more of a palm vein reader, a fingerprint scanner or reader, an iris scanner, a facial recognition system. In one particular exemplary embodiment, a palm vein reader, such as the PalmSecure™ by Fujitsu® is used as the primary biometric input device. The Fujitsu® PalmSecure™ authenticates users based on vein pattern recognition, rather than iris scanner or fingerprint readers. Veins are internal and have a wealth of differentiating features. Thus attempts to forge an indentify are extremely difficult, thereby enabling a high level of security. Such a reader features good authentication accuracy, while being non-intrusive and contactless—thus providing ease of use with virtually no physiological restrictions for all users.

In the present embodiment, the biometric provided is associated with that Patient's EMR/EHR in the Health Information Exchange (HIE). The HIE 260 includes a database or data store 220 and is operated by a third party. The HIE 260 interfaces over a secure network with the VSS software at each Provider 110. In other words, the biometric information of the Patient is not (or not only) stored locally in the EMR, but rather, is stored in a secure remote data store 220 of the HIE, which includes information (collected Patient data) from a plurality of unrelated practices 110. Alternately, if desired, the biometric information could also be stored in the Patient's EMR.

In the embodiment using a palm vein reader, biometric information of a Patient can be input simply by holding the palm above the reader and matching it to a database image to validate the Patient's identity. This is not meant to be limiting, as other types of biometric readers can be used. The use of such a biometric can be very useful if the Patient does not have a state issued ID (for example, the case of a minor child). In such a case, the initial registration of the Patient will be recorded in the Provider's EMRS (i.e., the EMRS 114 of a particular practice 110), and the biometric identification information will be added to the remote data store 220 of the remote, third-party medical information services Provider.

The secondary identification verification of the present embodiment provides an additional ability to correctly identify each individual Patient and positively validate their identity and coverage eligibility. Also, the use of a biometric absolutely confirms the Patient's presence at the health care practice 110, Provider or facility.

Thus, referring back to FIGS. 1, 2 and 6, a clerk at the End User (i.e., a practice 110, a medical facility, etc.) initiates check-in of the Patient. Information provided by the Patient is provided to/obtained from the Patient's EMR/EHR from the EHRS. VSS software operating in the background of the check-in computer harvests information from the patent's EMR and makes an eligibility call 610 to the third party, insurance eligibility services Provider, through load balancing and firewall software. Based on the harvested information, the HIE records eligibility for the Patient encounter and locates a biometric record, if one is stored in association with the patent in the data store 220.

More particularly, eligibility call 610 is used to determine if, first, there is an EMR/EHR for the Patient in the HIE. If not, the VSS enters a stand-alone eligibility flow. If so, the eligibility information for the Patient indicated by the EMR is obtained from the HIE. The VSS, in conjunction with the End User then determines what types of insurance the Patient is using for the current encounter, and if they are supported by the system. A determination regarding supported insurance types and Patient eligibility is then retrieved by the eligibility call and stored in the HIE. The HIE returns the eligibility information and a biometric result to the VSS for comparison with further information to be obtained during the check-in process.

The End User then electronically obtains identity information from the Patient. For example, biometric information is obtained by scanning the palm vein, fingerprint, iris, etc., of the Patient. Additionally, the End User can electronically read, or manually enter, information from the Patient's Official ID. If no Official ID is presented, this step is skipped. Alternately, if desired, a check of the biometric can be made before checking the Official ID and, if the biometric check determines a match, scanning of the Official ID can be omitted in certain cases, where a verified ID is associated with the biometric scan. If no biometric is on file for the Patient, then the Official ID photo cross check is used to primarily verify the identity of the Patient.

The biometric and Official ID information is processed by the VSS, which access the DMV database of the state issuing the Official ID, if one is provided, to obtain DMV information relating to the presented Official ID. The VSS then initiates cross checks 620 to ensure that the stored biometric matches the Patient's biometric and/or that the photograph in the state or federal database matches the Patient presenting to the End User. In particular, cross checks are performed to compare biometric information associated with the Patient (stored in the HIE) with the current scanned biometric of the Patient, and to compare a photograph from an official state or federal database record associated with the Patient to the person standing before the check-in clerk.

More particularly, the VSS prompts the check-in clerk at the End User to verify that the photograph of the Patient obtained from the state or federal database using the Official ID matches the person standing before the clerk. In short, the clerk is to enter yes or no as to whether the picture displayed on the clerk's computer, obtained from the state or federal database, is a picture of the person standing before the clerk and representing himself or herself as the Patient. The results of the biometric check and query are stored by the VSS software and are submitted to the rules system 270 of the remote HIE 260. The biometric information obtained at the present visit can additionally be stored in the data store 220 of the HIE 260 if no previous biometric was stored, or in addition to a previous biometric. Additionally, the HIE stores temporary (TEMP) Check-in information for the Patient obtained by the VSS. The VSS provides the End User with the Results of the analysis performed by the HIE. The results can be displayed to the user or check-in clerk via a display of the check-in computer being operated locally by the check-in clerk. The clerk views the check-in summary information provided from the HIE, via the VSS, and either approves or disapproves the information. If approved, the check-in results are provided to the EMRS for entry into the Patient's EMR and for storage in association with the Patient in the HIE. The Verification Services system then releases control of the check-in process to the EMRS, which returns to the standard EMR entry flow, and the End User can finish the Patient check-in process.

After the Patient receives treatment at the End User location, the treatment information is stored in the EMRS, as is typical. However, either periodically (batch) or in real-time (downstreaming), the EMRS provides the stored clinical treatment information to the HIE, for storage in the data store 220, in association with the Patient. These data become the basis for the historical information delineated on a Report 112 provided to the health care Provider. The HIE thus collects information that can be used to alert investigators as to potential fraud and to provide statistical and trend information for waste and abuse elimination.

Referring back to FIGS. 1-6, once the Patient check-in has been completed, but before the Patient receives treatment, the VSS software automatically generates a Fraud Probability Report 112 for use by a healthcare Provider at the practice. In one particular embodiment of the invention, the Fraud Probability Report 112 is a color-coded (i.e., following a Red-Yellow-Green type traffic-light metaphor), highly graphical, easy-to-understand report outlining the probability of fraud committed by the Patient at check-in. In addition to identifying anomalies detected during the Patient's identity validation, it analyzes recent Patient medical history (from previous visits), recent prescriptions, insurance eligibility, and other factors. The Fraud Probability Report 112 provides doctors and other healthcare service Providers with transparency and the tools to identify fraud, improve Patient care, and make medical decisions with more Patient information. It is important to note that the Fraud Probability Report 112 does not provide a determination of whether or not a Patient should receive care, but rather, the Fraud Probability Report 112 highlights key eligibility and behavioral issues for the Provider to consider. For example, the Fraud Probability Report 112 could be used to red-flag or identify drug-seeking behavior of a Patient, where the Patient visits different health care facilities and/or pharmacies with the same complaint and seeking the same prescription. Such “doctor-shopping” or “pharmacy-shopping” is immediately detected and highlighted by an Fraud Probability Report utilizing a centralized, third-party HIE 260, in accordance with the present invention.

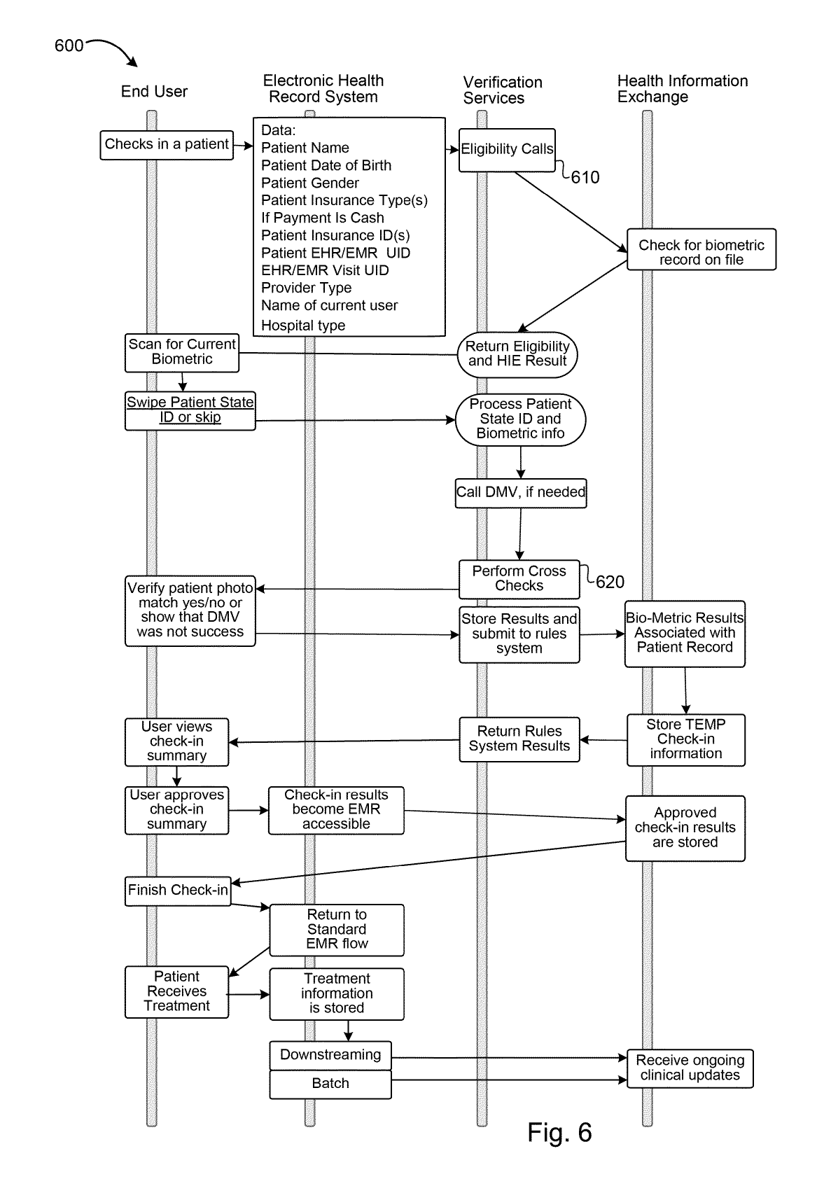

Referring now to FIG. 7, there is shown an adaptive fraud prediction system 700 in accordance with one particular embodiment of the present invention. The system of the present invention operates to collect and analyze medical integrity data, in real-time, using a scalable system architecture.

Layer 1 shows a variety of examples of software types with which the system of the present embodiment can interface. This is not meant to be limiting as other software types can be interfaced with the system of the invention without departing from the scope or spirit of the invention. In the particular example shown in FIG. 7, the End User can interface with the fraud prediction system of the present invention via a desktop application, such as Windows Presentation Foundation, Win Forms, App Plugins, etc., or via a web browser, such as Safari, Firefox, Chrome, Internet Explorer, etc.

Layer 2 is a front of tools associated with the adaptive fraud prediction system, but located at the End User location. One or more Layer 2 tools can be provided to the end user for purposes of information collection. The Layer 2 tools include such electronic input devices as biometric readers, barcode readers magnetic stripe readers, a software linkage to the HIE for accessing data therein, and collector and driver software for each. The collector software is custom code used to gather data and format it, typically as input data, from various sources. The driver software can be canned or custom code provided to interface with specific electronic input devices. The intelligence layer includes application code executable by a processor and stored in non-transitory memory at the End User location for performing various methods and functions of the invention. The intelligence layer of Layer 2 includes the VSS described in connection with FIG. 6.

Layer 3 includes the transmission control protocol (TCP) to facilitate secure transfer of data between the Provider's network (i.e., the End User) and the backend adaptive fraud prediction system of the present embodiment. In the present example, a WAN is illustrated for transmitting data, although other types of communication networks and systems may be used.

Layer 4 illustrates the intelligence controlling security, authorization and authentication systems of the adaptive fraud prediction system of the present embodiment.

Layer 5 shows exemplary backend facilities for handling and making decisions about biometrics, messaging, national Provider identification (NPI), insurance and Official ID information. On this level, the system manages the adaptive rules facility and the Patient facility.

Among other things, the adaptive rules facility of Layer 5 can be used to analyze and package data to assist in the identification of fraudulent practices. More particularly, in accordance with one particular embodiment of the present invention, a notification dashboard and analytic system can be provided to help Providers, payers and government special investigative units (SIUs) find fraud in the medical industry in less time than by conventional methods. By utilizing unique, real-time information brought into the HIE of FIGS. 2 and 6, waste, abuse and insurance fraud, including, but not limited to phantom billing, identity theft, improper diagnosis, improper coding, the presence of pill mills, can be identified. For example, in one particular embodiment of the invention, the system can alert &Us to fraudulent behavior before a bill has been submitted, even in elusive, remote care environments, by reporting to Payers and &Us, in real-time, information about Patient presence (i.e., if a Official ID was present, biometric evidence, photographic evidence, geolocation evidence, etc.); by providing Fraud Probability Reports to Healthcare Providers in the Payers network; and by reporting on the integrity of Providers in the Payer's network based on real-time visit data.

The systems and methods of the present invention are additionally useful in detecting fraud in delivery of medical equipment (DME), Medical Transports and in fraudulent billing practices for home healthcare (HH) visits. More particularly, the adaptive fraud prediction system of the present invention can be used to provide actionable alerts to a Payer based on suspicious activity and/or trends.

More particularly, in one particular embodiment of the invention, rules can be set by the Payer (using an interface to the system accessible by the Payer) to cause an alert to be sent to the Payer in the event of certain suspicious activity relating to DME or HH visits. The following is a non-limiting list of examples that can be used as the basis for a rules that could be set to produce an alert sent to the Payer:
If more than x′ percentage of ‘delivery’ transactions occur within the same geo-location radius, alert the Payer;
If more than a predetermined percentage ‘x’ of transactions occur without any ID input, alert the payer;
If more than a predetermined number ‘x’ of ‘delivery’ transactions occur within a predetermined timeframe, alert the payer;
If a DME order does not correspond with a visit logged in the HIE, alert the payer;
If more than a predetermined percentage ‘x’ of orders do not correspond with visits per DME Provider, alert the payer;
If a billed item sent via mail delivery is returned for any reason notify the payer;
If a mail delivery item has an invalid tracking number notify the payer and the DME Provider;
If an item sent for DME via mail delivery weighs too little, notify the Payer; or
If an item sent via mail delivery arrives at an address that is in a different state or other unexpected location, notify the payer.

Similarly, a Payer can use the collected data to determine the occurrence of fraud independently of receiving an alert. For example, in an HH system in which the Provider is required to photograph the Patient visited as part of the EHR, a Provider Patient gallery can be collected by the HIE for viewing by an investigator. Upon browsing a HH Provider Patient gallery, Investigators may find that the photos gathered for “ID verification” contain no Patients in the photos, or reveal that the Patients pictured are not bed-ridden, or that the Patients all seem to be in the same location (Nursing home, Doctors' office), etc.

By collecting primary care, Hospital, Clinic, DME and HH visit and other information, dashboard visualization tools will be able to spot relationships between care Providers based on the flow of Patient traffic.

The adaptive fraud prediction system of the present invention can additionally include software at the Payer location that is configured to assess DME and Medical Transport Providers and provide a prediction of fraud probability based on analysis of scheduling, tracking, and confirming remote visits. The Payer system provides this service by collecting a variety of information, including geo-location coordinates, time of day, shipping information, drop-off information and Patient presence verification.

In order to further delineate the services that the Payer Fraud Probability Prediction system provides, it is important to understand that there are certain background factors in the Patient care life-cycle that contribute to fraud (i.e., described further below), and that the VSS (FIG. 6) is already in place in some of those locations in order to facilitate real-time identification of the problem space.

1. Physician Visit/DME or Medical Transport is Ordered:

The Patient is seen by a Physician who issues a certification that they have seen the Patient and that the Patient needs DME or Medical Transport services. Such a visit is recorded in in the VSS (FIG. 6) of that physicians practice and, resultantly, stored in the HIE. However, fraud can occur in this situation as a result of: a) False diagnosis/up-coding—Diagnosing someone as terminally ill or bed-ridden in order to gain more money, or improper kickbacks for treatment/referral of the Patient; and/or b) Phantom Billing.

2A. DME Order Fulfillment:

Now a DME Provider receives the request for DME. IF the DME distributor intends to bill a Payer for the encounter he must have physician certification on file for the order. There are traditionally two main ways that a DME distributor may receive certification and the order:
1) The Patient will go to a store-front and purchase the item in person, bringing a paper certification; or
2) Certification may be electronically delivered, as an attachment in an email, fax etc.

Once the DME distributor receives certification for the order he fulfills it in one of the following ways:
1) It is given to the Patient or Patient representative right away (store front location);
2) It can be mailed via postal service; or
3) It can be couriered to the Patient's home, as it may be very heavy, and need a technician to assist with setup.

The industry problems that can arise from the above-described system include, but are not limited to:
For the Payer: A Provider bills for DME, when no DME was delivered;
For the Payer: Services rendered are based on fraudulent/phantom certification;
For the Payer: The item delivered does not match the item billed; and/or
For the Provider: DME Providers are being challenged and audited for payments and services.

2B. Non-Emergency Medical Transport Provided:

A medical transport company acquires the physician certification and begins scheduling pick-up and drop-off times for the Patient. The industry problems that can arise from this system include, but are not limited to:
For the Payer: A Provider bills for medical transport, when no transport was provided;
For the Payer: Services rendered are based on fraudulent/phantom certification;
For the Payer: Patients are being transported to non-medical appointments, at the cost of the payer; and/or
For the Provider: Medical transport Providers are being challenged and audited for payments and services.

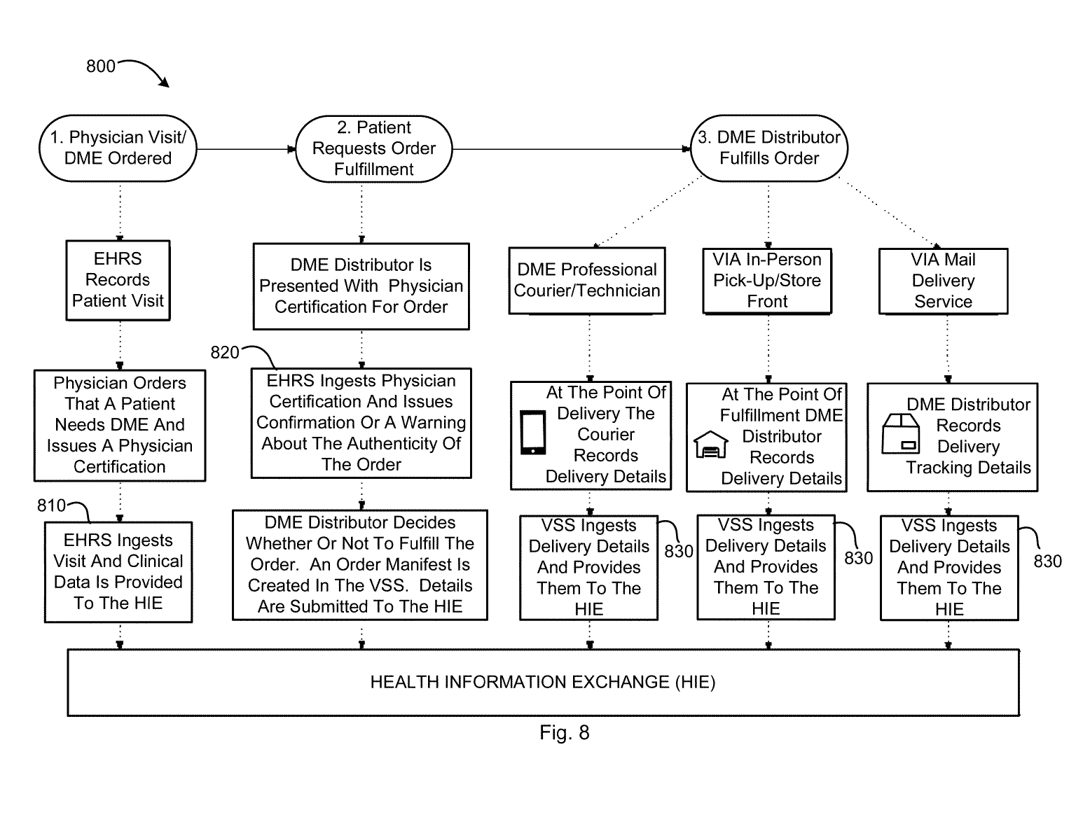

Referring now to FIG. 8, it will now be described one particular embodiment 800 of a Payer fraud prediction system to address and/or predict a probability of fraud occurring in particular Provider situations.

For in Person Pickup (DME):

As with the system described in connection with FIG. 6, an End User device carried by the DME Provider and executing VSS software is used to obtain a Patient/Beneficiary insurance ID for the Patient indicated in a Physician certification ordering DME. Then, the VSS software running on the End User device of the DME Provider requests that a Official ID of the Patient be provided. If a Official ID is not available, the local VSS software records that it is not available. The VSS obtains Doctor certification and DME order data provided by the software at the prescribing Doctor's practice to the HIE. Step 810. Prior to the DME, the fraud prediction system processes certification and order data and returns a report to the DME Provider location indicating whether the certification details entered by the DME Provider correspond to data from a Patient visit recorded in the HIE. Step 820. Upon confirmation of a DME from the DME Provider, the fraud prediction system of the present invention records the time and location of the fulfillment in the HIE. Step 830.

For Mail Delivery (DME):

The DME Provider system asks for a Patient/Beneficiary ID number and will in-take certification and DME order data from the HIE. The system returns a report to the DME Provider location indicating if the certification details entered corresponds with a visit stored by a practice in the HIE. The system then in-takes shipping company and tracking data. Software of the system obtains delivery information from shipping vendors using the tracking number input.

For Courier (DME):

Prior to delivery, Verification Services software being executed on an End User computer or device asks for the Patient/Beneficiary ID Number. Also prior to delivery the End User VSS in-takes certification and DME order data from the HIE and returns a report to the DME location indicating if the certification details entered correspond to a visit stored in the HIE. When the DME location administrator confirms the certification details, it places the order and the system adds the order to a delivery manifest. From this manifest the DME courier has a list of his deliveries accessible via a mobile application in communication with the HIE and/or the VSS. The mobile application is executed on a mobile device carried by the DME courier, such as, but not limited to, a mobile phone, smart phone, smart device, or tablet, or any other smart device including a camera and/or GPS circuitry. Additionally, in states that provide a magnetic stripe or barcode on the Official ID for electronic storage of ID data, a mobile reader that interfaces with the mobile device is also provided.

When the DME courier is at the Patient's home, the mobile application asks for the Patient's Official ID. If the Official ID is not available, the DME courier must take or obtain a picture of the Patient. This can be done using a camera of the mobile device. The VSS, working with the mobile application, records the time the Official ID of the Patient, or of the Patient's representative, or the picture of the Patient is input into the mobile application. Additionally, the mobile application uses geo-location to determine the courier's position and associate it with the delivery record. For example, the mobile application may access an integral GPS locator device of the mobile device to obtain geo-location data (i.e., current geographical position) of the mobile device at the time the delivery is marked as completed and associate it with the Patient's record in the HIE.

For Medical Transport:

Prior to pick-up, the system asks for the beneficiary ID Number and in-takes certification and transport Data from the HIE. Also prior to pick-up, the system software returns a report to the medical transport Provider location/administrator indicating if the certification details entered by the medical transport Provider correspond to a visit stored in the HIE. Once the medical transport Provider location confirms the schedule, the system adds the order to a delivery manifest. From this manifest, the medical transport driver has a list of their pickups accessible via mobile application in communication with VSS of the medical transport Provider and/or the HIE. When the medical transport driver is at the Patient's home the system uses the mobile application ask for the Patient's Official ID. If the ID is not available, the driver must take or obtain a picture of the Patient. The system, via the mobile application, records the time that the ID of the Patient, or Patient's representative, is input. Additionally, the system uses geo-location to determine the courier's position. For example, a GPS device integral to the mobile device can provide position data to be stored in association with the Patient data indicating a place where the pick-up and/or drop-off occurred.

Thus, the system of the present invention provides medical transport drivers and/or DME couriers with an easy to use interface that produces a quick and efficient way to report pick-up and drop-off status, geo-location, and Patient's Official ID as they visit Patients remotely. By collecting information of the Patient's Official ID the system verifies that a Patient was present at the visit/delivery. Additionally, by collecting photos of the Patient, the system of the present embodiment may expose Patients whom are falsely diagnosed, or are not actually present. By recording the time the Patient's Official ID is input, the system also keeps track of the length of time between deliveries or pick-ups and drop-offs, in order to evaluate their legitimacy. Further still, by locating the courier/driver's position, the system verifies that the courier/driver traveled to a remote location, which may or may not correlate with the Patient's known address. If the courier/driver tries to report a new pick-up without leaving the area, the system of the present embodiment can be programmed to flag the encounters.

The above-described systems can additionally be used for monitoring HH Providers by, among other things, requiring the HH Provider to log Patient visits utilizing a mobile application; ingest and verify state ID; obtain pictures of the Patients visited; and log GPS data of the visit in association with the clinical treatment data record. The geo-location of HH Providers can be used to determine if a Provider is fraudulently billing for services not rendered (i.e., not provided at a particular location and/or for a particular length of time).

As with the previously described embodiments, the system can be configured to provide Payer alerts in the event that the analyzed data indicates suspicious activity or trends. Examples of rules that can be configured (i.e., through system programming) for the Payer to discover suspicious trends and for which alerts can be provided include, but are not limited to:
If more than a predetermined amount of transactions ‘x’ occur within the same geo-location radius, alert the payer;
If more than a predetermined percentage ‘x’ of transactions occur without any Official ID input, alert the payer;
If any transaction occurs without identification of any kind, no photo, no Official ID, no geo-location, notify the payer;
If more than a predetermined number of ‘delivery’ transactions ‘x’ occur within timeframe, alert the payer;
If a DME order does not correspond with a visit logged in the HIE, alert the payer;
   For Medical transport, if a pick-up occurs in the same place as a drop-off then notify the payer;
For Medical transport, if a pick-up and drop-off occur within a predetermined amount of time (e.g., 2 minutes), notify the payer;
For Medical transport, if a pick-up and another pick-up occur before any drop-off notify the payer; and/or
For Medical transport, if a pick-up occurs in the same place as another pickup in one day notify the payer.

As with the previously described embodiment, a Provider Patient gallery of pictures can be formed from picture data gathered for “ID verification” in lieu of actual ID and stored in the HIE, which Investigators may find beneficial to browse. For example, in browsing a collection of pictures obtained by a courier, medical transport driver or HH Provider, an investigator may find that there are no Patients in the photos, that the Patients pictured are not bed-ridden, that the Patients all seem to be in the same location (Nursing home, Doctors' office). Additionally, investigators will have access to location and other meta-data from the photos taken, if it is available. Further, by using dashboard visualization tools, investigators will be able to spot relationships between Doctors and DME/Medical transport/HH Providers based on the flow of Patient traffic.

Further still, in one particular embodiment of the invention, the system is configured to include software local to a Payer, yet in communication with the HIE, that can assess a probability of fraud among remote care Providers, by viewing collected scheduling, tracking, and confirmed remote visits data. Software in accordance with one particular embodiment of the invention is configured to provide this service by collecting a variety of information, including geo-location coordinates, time of day and Patient presence verification.

Certain problems are present in the healthcare industry with regard to HH Providers. For example, it is possible for a Provider to give the Patient a diagnosis that makes the Patient eligible for home health care services. At this point, the system of the present invention has already collected some data about this visit and has stored it in the HIE. One problem in this industry involves giving a false diagnosis/up-coding (i.e., diagnosing someone as terminally ill or bed-ridden in order to gain more money, or improper kickbacks for treatment/referral of the Patient). With the qualifying diagnosis in place a Home Health Care Provider, who may not be a physician, will travel to the Patient's house, along with the homes of other Patients. However, the following types of problems can occur under these circumstances:
For the Payer: Phantom Services—Provider bills for home health care services and travel, when no travel or services occurred;
For the Payer: Services rendered are based on fraudulent diagnosis;
For the Payer: Services rendered at the location do not match the services billed;
For the Provider: Providers are being challenged and audited for payments and services; and
For the Provider: Many independent home health care Providers and CNAs do not use any practice management technology. People in these positions are calling up the insurance company, often at the Patient's door to verify eligibility. This costs a considerable amount of time, which impacts how many people a Provider can see in a day;

For purposes of uncovering the foregoing fraudulent activities, the present particular embodiment of the invention uses data in the HIE and obtained by the HH (used interchangeably with the phrase “remote care”) Provider to locate suspicious patterns/trends that can indicate fraudulent activity. In one particular embodiment of the invention, the HH Provider will be provided with a mobile device, such as a smart phone, smart device, tablet or other smart device including a camera and, in one particular embodiment, a GPS module. Using software stored in non-transitory memory and executed by a processor of the mobile device, the system will ask for the Patient/Beneficiary ID number. Additionally, the system will intake-scheduling data and create a manifest of remote visits from the schedule. When the HH Provider is at the Patient's home, the system will prompt the HH Provider to ask for the Patient's Official ID. If the Patient's Official ID is not available, the care Provider must take or otherwise obtain a digital image of the Patient. The system will record, among other data, the time the Patient's Official ID is input. In one particular embodiment of the invention, the system will additionally triangulate the care Provider's position using a GPS module, or other position determination system of the mobile device.

Additionally, in the present particular embodiment, the software is configured to monitor location data from the position/GPS module and close the remote visit when the HH Provider leaves the area by more than a predetermined distance. If triangulation services are not available however, the HH Provider manually closes the visit.

Additionally, if the care Provider tries to create a new visit without leaving the area, mobile device application software of the present embodiment will record the time and geo location of the last visit. If position/triangulation data is not available then the system will record the time and geo-location of the manual close, however, visits of this type will be flagged.

By in-taking scheduling information, the system of the present embodiment creates a manifest of the visits that will need verification. By creating this manifest, HH Providers have an easy to use list that enables a quick and efficient way to check-in each Patient as HH Provider visits them remotely, without having to manually input insurance information while on the go. Additionally, by collecting electronic information from the Patient's Official ID, the system of the present embodiment provides verification that the Patient was actually present at the visit. Through the collection of Patient photographs, the system may expose Patients whom are falsely diagnosed (i.e. not bed-bound). And, by recording the time the Patient's Official ID is electronically read by an electronic reader in communication with the mobile device, and the time that the HH Provider proceeds a predetermined distance away from the treatment location, the present system can calculate the length of the HH Provider's visit. By closing the visit based on predetermined distance, the system of the present embodiment can calculate the length of the visit based on the time the HH Provider arrived at the address, and the time the HH Provider left the address. This doesn't require any more work for the HH Provider to close the visit.

Further, by triangulating the HH Provider's position, the system can be used to verify that the care was provided at a remote location, which may or may not correlate with the Patient's known address. If triangulation services aren't available, the system can be configured by software to provide an alternative way for the HH Provider to close the visit manually. It should also be noted that, by recording that the HH Provider has not left the area, the system of the present embodiment exposes phantom billing and/or clusters of up-coded Patients within a single community.

As with the previously described embodiments, the system described in connection with the present embodiment can be configured (i.e., by programmed rules and/or software) to provide alerts in the event that the analyzed data indicates suspicious activity or trends. Examples of rules that can be configured for Payers to discover suspicious activities and trends involving an HH Provider, and for which alerts can be provided include, but are not limited to:
If more than a predetermined percentage ‘x’ of transactions occur within the same geo-location radius, alert the payer;
If more than a predetermined percentage ‘x’ of transactions occur without any ID input, alert the payer; and
If more than a predetermined number of transactions ‘x’ occur within a predefined time frame, alert the payer.

As with the other embodiments, the photographs taken by a particular HH Provider for “ID verification” in lieu of an actual Official ID can be used to form a Patient gallery, which Investigators may find beneficial to browse. By using this Patient gallery investigators may find, among other things, that there are no Patients in the photos, that the Patients are not bed-ridden, or that the Patients all seem to be in the same location (Nursing home, Doctors' office).

In accordance with the foregoing, it can be seen that the present invention utilizes an adaptive algorithm that can provide, in real-time, an indication regarding a level of probability that a health care transaction is fraudulent. This information can be provided to a government agency or other payer to evaluate and cross check a claim before funds are disbursed. This eliminates the “pay and chase” methodology in place today throughout the government, without introducing any impediment to Patient care. Additionally, the system of the present invention can be used to detect and prevent both beneficiary-fraud (i.e., identity theft, Patient involved fraud, drug seeking behavior, doctor-shopping, pharmacy-shopping) and Provider-fraud (i.e., phantom billing and medical equipment delivery fraud, etc.) prior to disbursement of significant funds.

The systems of the present invention also deliver a powerful “observer effect”, as fraudulent Providers of all types and beneficiaries understand that the health care process is being watched. The consequence is similar to the reduction in crime in a geographical area resulting from an increased, visible police presence.

The present invention provides a HIPAA compliant data collection and fraud prediction system and method as described herein. Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

1. A system for verifying insurance eligibility of a patient, comprising:
a first computer at a provider location, said first computer including an electronic data reader for obtaining electronic data of a patient; and
said first computer configured to connect to a remote computer system to verify eligibility information of the patient based on information from an insurance card of the patient and the electronic data of the patient.

2. The system of claim 1, wherein the data reader reads a biometric of the patient and uses the biometric and information from the patient's insurance card to verify insurance eligibility of the patient.

3. The system of claim 1, wherein the data reader is configured to obtain electronic data of a patient from an officially issued identification card presented by the patient.

4. The system of claim 3, wherein the first computer accesses a remote database of an entity issuing the officially issued identification card and the remote database is configured to use the electronic data to provide a photograph associated with the officially issued identification card to the first computer.

5. The system of claim 4, wherein the first computer includes a display for displaying the photograph to an operator of the first computer for comparison with the patient.

6. The system of claim 4, wherein the remote computer system is a health information exchange that analyzes information of the patient provided from the first computer and from information stored in a database of the health information exchange to return information regarding the patient's eligibility for treatment to the first computer.

7. The system of claim 6, wherein the information is analyzed according to a set of rules stored in the remote computer system.

8. The system of claim 6, wherein a report is generated using the returned information and provided to the first computer, said report including said photograph.

9. The system of claim 8, wherein said report additionally includes an indication of a level of probability that the Patient transaction is fraudulent.

10. A method of verifying insurance eligibility of a patient at a provider location, using a system according to claim 1, the method comprising the steps of:
entering insurance information of a patient into the first computer;
using the electronic data reader to obtain electronic data of the patient;
providing the insurance information and electronic information to the remote computer system to verify insurance eligibility of the patient.

11. The method of claim 10, wherein the electronic data is a biometric of the patient.

12. The method of claim 10, wherein the electronic data is obtained by the electronic data reader by electronically reading information of an officially issued identification card presented by the patient and the method further comprises the steps of:
based on information obtained electronically from the officially issued identification card, providing a photograph associated in a remote database with the officially issued identification card to the first computer; and
comparing the provided photograph with the patient to verify eligibility.

13. The method of claim 12, further comprising the step of providing a report at the provider location including an indication of a level of probability that a Patient transaction is fraudulent.

14. The method of claim 13, wherein the report additionally includes the photograph.

15. A system for determining a level of probability of healthcare fraud, comprising:
a data collector at a Provider location;
a data analyzer at a collection remote from the Provider location, said data analyzer de-identifying and transforming data received from said data collector;
a database storing the de-identified and transformed data in a non-transitory form; and
a rules engine for processing the de-identified and transformed data to determine a level of probability of fraud based on a set of defined rules.

16. The system of claim 15, further comprising a report generator for generating a fraud probability report based on the processed data.

17. The system of claim 16, wherein the report generator generates the fraud probability report in real-time.

18. The system of claim 16, wherein the report includes a visual indicator representing a level of probability that a Patient transaction is fraudulent.

19. A system for determining a level of probability of healthcare fraud, comprising:
a data collector at a Provider location for collecting data regarding the execution of a healthcare transaction, wherein the Provider provides at least one of a delivery of medical equipment, medical transport and home healthcare services;
a database storing data received from said data collector in a non-transitory form;
a data analyzer for processing the stored data to determine a level of probability of fraud based on a set of defined rules.

20. The system of claim 19 further including a report generator for generating and providing a report indicating a level of probability that the healthcare transaction is fraudulent.
